(19) United States
(12) Patent Application Publication
(10) Pub. No.: US 2012/0198914 A1
(43) Pub. Date: Aug. 9, 2012

(54) Pressure Activated Sampling System

(75) Inventors: David H. Fine, Cocoa Beach, FL (US); Ravi K. Konduri, Heathrow, FL (US); Edward E. A. Bromberg, Orlando, FL (US); Heather Macuszonok, Orlando, FL (US); Eric Moy, Orlando, FL (US); Yarelis M. Rios, Orlando, FL (US)

(73) Assignee: L-3 Communications CyTerra Corporation, Orlando, FL (US)

(21) Appl. No.: 12/136,223

(22) Filed: Jun. 10, 2008

Related U.S. Application Data
(63) Continuation-in-part of application No. 11/691,036, filed on Mar. 26, 2007.
Application No. 11/691,036 is a continuation of application No. 11/087,818, filed on Mar. 24, 2005, now Pat. No. 7,204,125.
Application No. 11/087,818 is a continuation of application No. 10/316,746, filed on Dec. 11, 2002, now Pat. No. 6,895,801.
(60) Provisional application No. 60/338,705, filed on Dec. 11, 2001.

(51) Int. Cl. G01N 1/22

(52) U.S. Cl. 73/23.41

(57) ABSTRACT

Screening an item for prohibited material may include multiple pressurization and rapid depressurization cycles. Screening an item for prohibiting material may include a pressurization chamber including one or more items to be screened for prohibited material and one or more filler objects.

### CROSS-REFERENCE TO RELATED APPLICATION

This application is a continuation-in-part of U.S. application Ser. No. 11/691,036, filed Mar. 26, 2007 and titled Pressure Activated Sampling System, which is a continuation of U.S. application Ser. No. 11/087,818, filed Mar. 24, 2005, titled Pressure Activated Sampling System and now U.S. Pat. No. 7,204,125, which is a continuation of U.S. application Ser. No. 10/316,746, filed Dec. 11, 2002, titled Pressure Activated Sampling System and now U.S. Pat. No. 6,895,801, which claims the benefit of U.S. Provisional Application No. 60/338,705, filed Dec. 11, 2001, all of which are incorporated by reference in their entirety.

### TECHNICAL FIELD

This description relates to detection of dangerous or illegal materials, and more particularly to the automated detection of explosives and chemical and biological agents in luggage or other containers.

### BACKGROUND

Airport security screening services protect travelers, air transportation personnel, facilities, and equipment against terrorist and other criminal acts. The heightened awareness of security in the aviation industry has resulted in added focus on the effectiveness of detecting explosives, chemical and biological agents, and other dangerous or illegal materials in luggage and other cargo. Explosives Detection Systems (EDS) have been deployed at airports across the U.S. for screening checked luggage. Most EDS screening uses Computer tomography (CTX) machines that rely upon imaging technology to detect explosives. In addition, Explosives Trace Detection (ETD) devices are currently being used to detect the presence of explosive materials in checked or carry-on bags. Prior to Sep. 11, 2001, EDS screening was primarily used for a relatively small number of checked bags belonging to passengers who were selected randomly or by a Computer Assisted Passenger Prescreening System (CAPPS). After September 11, a goal was set to achieve 100 percent screening of all checked bags by Dec. 31, 2002.

For example, to facilitate comprehensive baggage screening in small airports or small screening stations at larger airports, the Transportation Security Administration (TSA) has developed the ARGUS EDS program, which is intended to be a low cost, low throughput bag inspection system. The program guidelines establish certain criteria for a new class of EDS. For example, the program requires a certain automated detection success rate, establishes a maximum false alarm rate, specifies a minimum throughput, and places restrictions on the size of the machine.

### SUMMARY

Techniques are provided for screening items, such as luggage, mail, packages, or cargo containers, for contaminants, such as those that may evidence the presence of prohibited materials. An item to be screened is subjected to pressurization to a predetermined pressure level and then is subjected to rapid decompression to the ambient atmospheric pressure. The rapid decompression serves to strip particles and scavenge vapors from interior and exterior surfaces of the item and the contents of the item. These particles and vapors are sampled by a sample collection medium, which is then analyzed contaminants indicating the presence of explosives, biological agents, chemical agents, and/or narcotics.

In one general aspect, screening an item for prohibited material includes a pressure chamber adapted to contain at least one item to be screened for prohibited material and being adapted to contain at least one filler object, a pressurized gas source connected to provide pressurized gas to the pressure chamber, a valve for venting the pressure chamber to an ambient atmosphere, a controller operable to control a pressurization of the pressure chamber by the pressurized gas source and to control the valve to initiate a rapid decompression of the pressure chamber, and a sample collector positioned to collect samples of substances removed from the at least one item by the rapid decompression.

Implementations may include one or more of the following features. For example, a filler object may be or include a substantially incompressible filler object, a polyurethane foam object or a formed metal object. A filler object may be located at least partially beneath, at least partially above, or adjacent to the item to be screened for prohibited material. The pressure chamber may include a door for loading an item to be screened into the pressure chamber and a filler object may be connected to the door.

In another general aspect, screening an item for prohibited materials includes placing an item in a pressure chamber where the pressure chamber includes at least one filler object, pressurizing the pressure chamber up to a predetermined pressure level, decompressing the pressure chamber at a rapid rate relative to a rate of pressurization, and collecting samples of substances removed from the item by the rapid decompression.

Implementations may include one or more of the features noted above and one or more of the following features. The rapid rate may be at least about ten times the rate of compression. Pressure pulses may be generated after the pressure chamber reaches the predetermined pressure level and before the rapid decompression of the pressure chamber. Venting the pressure chamber to the ambient atmosphere may allow air to escape the pressure chamber at a high velocity. The high velocity may be a velocity sufficient to effectively strip particles adhering to a surface of the item.

In yet another general aspect, screening an item for prohibited material includes a pressure chamber adapted to contain at least one item to be screened for prohibited material, a pressurized gas source connected to provide pressurized gas through multiple nozzles to the pressure chamber, and multiple valves for venting the pressure chamber to an ambient atmosphere. Screening an item includes a controller operable to control multiple pressurizations of the pressure chamber by the pressurized gas source and to control the valves to initiate rapid decompressions of the pressure chamber opening some but not all valves to vent the pressure chamber and initiate a purge of the pressure chamber after the rapid decompression by opening additional valves to vent the pressure chamber than used in the rapid decompression of the pressure chamber and using the multiple nozzles to provide gas to the pressure chamber. A sample collector is positioned to collect samples of substances removed from the at least one item by the rapid decompression.

Implementations may include one or more of the features noted above and one or more of the following features. The purge may be initiated once the pressure in the pressure chamber falls to a preset pressure level.

In a further general aspect, screening an item for prohibited materials includes placing an item in a pressure chamber and pressurizing the pressure chamber a first time up to a first predetermined pressure level. After pressurizing the pressure chamber the first time, decompress the pressure chamber a first time at a first predetermined rapid depressurization rate. After decompressing the pressure chamber the first time, pressurize the pressure chamber a second time up to a second predetermined pressure level. After pressurizing the pressure chamber the second time, decompress the pressure chamber a second time at a second predetermined rapid depressurization rate. Collect, from the sample collector, samples of substances removed from the item by the rapid decompressions.

Implementations may include one or more of the features noted above and one or more of the following features. The first predetermined pressure level may be substantially the same as the second predetermined pressure level. The second predetermined pressure level may be higher than the second predetermined pressure level.

Decompressing the pressure chamber a second time may include decompressing the pressure chamber a second time at a predetermined rapid depressurization rate by opening some but not all pressure valves to vent the pressure chamber. When the pressure in the pressure chamber has reached a predetermined purge pressure level that is less than the second predetermined pressure level, the pressure chamber may be purged by opening additional pressure valves to vent the pressure chamber and opening nozzles to provide a gas flow in the pressure chamber from the nozzles toward a sample collector. The pressure chamber may include at least eight valves, depressurizing the pressure chamber may include opening at least five valves, and purging the pressure chamber may include opening at least three valves.

In still another general aspect, screening an item for prohibited materials may include placing an item in a pressure chamber and pressurizing the pressure chamber a first time up to a first predetermined pressure level. After pressurizing the pressure chamber the first time, decompressing the pressure chamber a first time at a predetermined rapid depressurization rate. After decompressing the pressure chamber the first time, pressurizing the pressure chamber a second time substantially up to the predetermined pressure level. After pressurizing the pressure chamber the second time, decompressing the pressure chamber a second time at a second predetermined rapid depressurization rate. After decompressing the pressure chamber the second time, pressurizing the pressure chamber a third time up to a second predetermined pressure level, the second predetermined pressure level being a higher pressure level than the first predetermined pressure level. After depressurizing the pressure chamber the third time, decompressing the pressure chamber a third time at a third predetermined rapid depressurization rate by opening some but not all pressure valves to vent the pressure chamber. When the pressure in the pressure chamber has reached a predetermined purge pressure level that is less than the second predetermined pressure level and greater than the first predetermined pressure level, purging the pressure chamber by opening additional pressure valves to vent the pressure chamber and opening nozzles to provide a gas flow in the pressure chamber from the nozzles toward a sample collector. Collect, from the sample collector, samples of substances removed from the item by the rapid decompressions and purge. Implementations may include one or more of the features noted above.

Implementations of the techniques discussed above may include a method or process, a system or apparatus, or computer software on a computer-accessible medium. The details of one or more of the implementations are set forth in the accompanying drawings and description below. Other features will be apparent from the description and drawings, and from the claims.

### DESCRIPTION OF DRAWINGS

FIGS. 1 and 4 are schematic cross-sectional side view diagrams of an automated pressure activated sampling systems.

FIG. 2 is a schematic cross-sectional front view diagram of the automated pressure activated sampling system of FIG. 1.

FIGS. 3 and 5 are flow diagrams of processes for screening a container for contaminants.

Like reference symbols in the various drawings indicate like elements.

### DETAILED DESCRIPTION

A pressure activated sampling system (PASS) uses very fast decompression to scavenge and eject a trace-vapor sample from an explosive device in luggage or other containers onto a suitable collector. The collector is then analyzed using a TSA-approved trace detector to detect the presence of explosive material. The PASS provides an automated sampling system that can be used for 100 percent baggage screening and that provides significant advantages over current baggage screening systems. For example, the PASS can significantly increase throughput, require much less space, detect much smaller explosive devices, and be implemented at a much lower cost. The PASS does not require X-ray radiation and thus does not damage film. In addition, the PASS can identify the explosives detected and can be upgraded to simultaneously sample for both chemical and biological agents and other hazardous or illegal materials.

A PASS can also be used to screen other types of containers or packages and, in large-scale implementations, even large seagoing cargo containers. In general, the PASS includes a pressure chamber, a compressor, a sample collector, and a trace level detector. The object to be screened is placed in the pressure chamber, and the chamber is slowly pressurized (e.g., over about ten to twenty seconds) to at least about two atmospheres (or in other implementations to at least about three atmospheres, or to about five or six atmospheres). Pressure in excess of six atmospheres can be used, although it has not generally been found to improve the results. Once approximate pressure equilibrium is achieved, the pressure chamber is rapidly decompressed (e.g., at a rate that requires less than a second or even less than half a second to reach atmospheric pressure) by venting the chamber to the ambient atmosphere. The air rushing out of the chamber is sampled and presented to a trace detector for analysis.

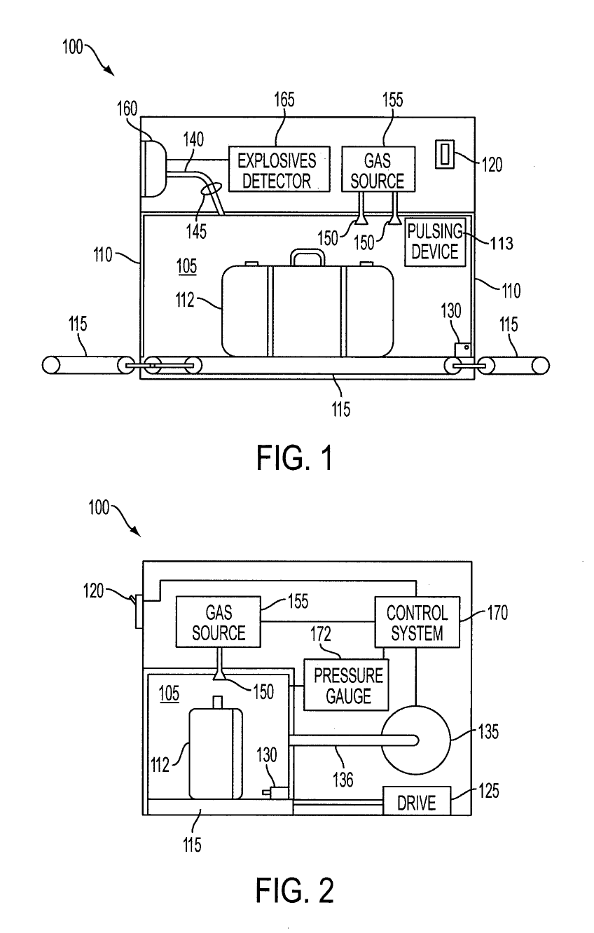

FIG. 1 shows a schematic cross-sectional side view diagram of an automated PASS 100 and FIG. 2 shows a schematic cross-sectional front view diagram of the automated PASS 100. The PASS 100 includes a pressure chamber 105 that includes roll-up doors 110 that are fitted with pressure seals to prevent air from leaking out of the pressure chamber 105 around the edges of the doors 110. One implementation employs an off-the-shelf pressure vessel. For example, there are autoclave sterilization chambers with the proper dimensions and characteristics that are available virtually off-the-shelf. The pressure chamber 105 is sized to accommodate the largest possible bag. As a result, three to six conventionally sized bags can typically be loaded into the pressure chamber 105 simultaneously. This increases the throughput of the system and often allows all of an individual's or a family's luggage to be tested at the same time.

To perform screening, one or more pieces of luggage 112 are placed on a conveyor 115. An operator uses a switch 120 to activate a mechanical conveyor drive system 125 to load the luggage 112 into the pressure chamber 105. A light beam detector 130 or some other object detection mechanism automatically determine whether there are any straps or other objects that could interfere with the proper closing of the roll-up doors 110. The roll-up doors 110 close automatically, and safety interlocks are used to ensure that the pressure chamber 105 remains sealed during the pressurization process.

A compressor 135 slowly pressurizes the pressure chamber 105 through a pipe 136. The pressurization forces air into the interior of the luggage 112, including the interior of any improvised explosive device (IED) or electronic items inside the luggage 112. If a lower pressure is used, the length of time in which it takes to reach approximate pressure equilibrium may be longer relative to the length of time required with a higher pressure. For example, by pressurizing the pressure chamber 105 to about two to three atmospheres, pressure equilibrium may require about 15 to 20 seconds. By slowly pressurizing the chamber to about five to six atmospheres over a period of about 10 seconds, on the other hand, a pressure level can be quickly achieved inside the luggage 112 so that air stripping is more powerful. In addition, high-level pressurization provides more reliable penetration of tightly packed items that might otherwise form “seals” that prevent air from entering. The length of time required to reach pressure equilibrium may also depend on how tightly packed items are in the luggage 112. The pressure chamber 105 may be maintained at high pressure for as long as necessary to achieve pressure equilibrium. However, as discussed herein, pressure equilibrium does not require absolute equilibrium but merely that the pressure in the pressure chamber reaches some degree of stability and is not changing significantly. Generally, this approximate pressure equilibrium can be achieved within about 15 seconds at five to six atmospheres. In general, the pressurization is slow relative to the subsequent rapid decompression, with the rates of pressurization and decompression differing from one another by an order of magnitude or more.

In one implementation, pressure equilibrium is followed by a few seconds of pressure pulsing. Pressure pulsing generally involves varying the pressure by ten to twenty percent in either direction from the pressure equilibrium level. The pressure internal to the chamber can be pulsed using a piston or a bladder-type container inside the pressure chamber 105. Such pressure pulsing has the effect of pumping air into and out of the luggage 112, which enhances the collection of potential explosive particles.

Pressurization is followed by a rapid decompression, which is accomplished by venting the pressure chamber 105 to the ambient atmosphere. A vent 140 includes a valve 145 that is opened to allow the pressurized air within the pressure chamber 105 to escape at high velocity. The high air velocity and momentum changes associated with the rapid decompression effectively strip particles from surfaces both inside and outside of the luggage 112. In particular, the high velocity air overcomes particle adherence to surface and other boundary conditions that might otherwise prevent a particle from leaving the surface under low pressure vacuum or air sweeping. This disruption expels any traces of explosive residue from inside the luggage 112, including from the surface and surrounding air of any explosive charge itself, and creates an air mass that is enriched with vapors and particles.

Once the pressure chamber 105 reaches or is near the ambient air pressure, one or more gas nozzles 150 connected to a gas source 155 can be used to clear or purge the remaining particle-enriched and vapor-enriched air from the pressure chamber 105. Generally, the air that remains in the pressure chamber 105 after the decompression includes enhanced levels of vapors and particles scavenged from the luggage 112. During decompression, molecules are removed from surfaces through disruption of the air/surface boundary layer and end up being dispersed throughout the pressure chamber 105 after decompression. The purging process serves to effectively “sanitize” the pressure chamber 105 by expelling any residual particles and vapors from the pressure chamber 105. This helps prevent particles and vapors from contaminating the pressure chamber 105 during subsequent screening of other items of luggage. In addition, the residual particles and vapors that are expelled during this purging process can be sampled to test for explosive residue. In one implementation, the nozzles are oriented to direct the residual particles and vapors toward a sample collection medium. The gas used during the purging process can be either ambient or purified air or some type of inert gas, such as argon. In one implementation, a single compressor or gas source can be used in place of the gas source 155 and the compressor 135.

The vent 140 is fitted with one or more sample collection devices 160. During the initial stages of the decompression, when air velocity is very high, the sample flow is too high for use of an ordinary sample collection media. Accordingly, an impact-type collection system is used, in which particles are collected by impacting a plate, which, in different implementations, may be a metal plate or a soft and pliable surface. Two or more segments of the exit airflow can also be separately sampled. For example, during the later stages of the decompression and during the purging process, a filter, such as a high efficiency filter, may be used as the sample collection medium. Time selective sampling of the exit airflow may also be used to collect samples from the portion of the air that was in close contact with the contaminated surfaces. Generally, the air that escapes just as the pressure chamber 105 is vented does not have a significant amount of vaporous or molecular material from the luggage 112. Instead, the portion of the air stream that exits when the pressure in the pressure chamber 105 is near atmospheric pressure or during the gas purge is most heavily enriched with vapors and particles from the luggage 112 and its contents. Accordingly, samples may be collected only during these later stages of the overall process.

A trace-level explosives detector 165 next analyzes the collected sample or samples. In one implementation, the trace-level explosives detector 165 includes an ion mobility spectrometry (IMS) detector and performs a software-based analysis of the sample. Software algorithms that recognize explosives have already been developed for the FAA-approved trace-particle detectors. When ion mobility spectrometry is used, for example, the trace-level explosives detector 165 can analyze the output of the ion mobility spectrometry detector to determine whether any explosive material is present. When a filter is used to collect samples, the filter itself may be presented (either manually or automatically) for analysis by ion mobility spectrometry or gas chromatography in connection with chemiluminescence detection performed, for example, by the trace-level explosives detector 165. The output of the ion mobility spectrograph or the gas chromatograph then may be analyzed by software running on a microprocessor within the trace-level explosives detector 165.

Generally, the overall screening process can be performed by a control system 170 that is connected to and controls the conveyor drive system 125, the roll-up doors 110, the compressor 135, the valve 145, the gas source 155, and the trace-level explosives detector 165. In addition, the control system 170 is further connected to and activated by the switch 120. The control system 170 is generally implemented as a processor programmed to control the overall screening process.

In one implementation, the entire cycle of loading a bag into the system, pressurization, decompression, sample collection, analysis and ejection of the bag from the system takes about 60 seconds. At an average of at least three bags per cycle, one can expect a throughput of 180 bags per hour for a single pressure chamber 105. However, because the sampling and not the analysis is the rate determining step, at a small increase in cost, one analysis device can easily support two or more sampling front ends (i.e., pressure chambers 105) simultaneously, leading to an expected throughput of about 360 or more bags per hour.

The trace-level explosives detector 165 may include or be similar to existing trace-particle detectors that have been approved by the TSA for use with carry-on luggage. These detectors have been shown to be capable of reliably detecting and identifying trace residue that is presented to them. The interpretation of the output of these detectors is well developed and fully automated without human input. However, these detectors only work well if the outside of the luggage is contaminated with explosive residue and if the person that samples the object happens to scavenge the precise location of the residue. Thus, the effectiveness of these detectors is typically dependent upon the skill of the operator in obtaining a chance contamination on the outside of the luggage. A terrorist may have become aware of this limitation and taken precautions to ensure that there is little, if any, residue on the outside of the luggage. The described techniques, however, are independent of chance contamination on the outside or even on the inside of the suitcase, and instead rely on harvesting enough explosive residue from the main explosive charge of the IED itself.

Although generally described in connection with sampling for explosive residue, the techniques can also be used to sample other types of trace compounds from within a suitcase. By including other trace-level detectors, or by modifying the trace-level explosives detector 165 to recognize additional contaminants, the same equipment can be used to sample for other trace materials such as chemical and biological agents and narcotics, although detection of biological agents may require other types of trace-level detectors, such as polymerase chain reaction or immunoassay detection systems.

Some prior approaches to sampling for contaminants have used both pressure and vacuum for sampling. The PASS uses pressure only, and achieves the same goal by decompressing to atmospheric pressure. The PASS has significant advantages over a dual pressure-vacuum system. For example, the PASS eliminates the need entirely for a very large vacuum pump. The rate of decompression can be significantly increased by using pressure alone, instead of relying upon the pumping capacity of the vacuum pump. In addition, there is no vacuum system to contaminate. The complexity and cost of the containment vessel and all the seals are greatly reduced because a pressure-only system does not have to handle both pressure and vacuum and does not require two-way valves. The use of a gas purge instead of a vacuum is also beneficial because the purging process displaces and concentrates the particle-enriched and vapor-enriched air.

Particularly in sampling large seagoing containers, ultrasonic vibration can also sometimes help loosen particles. Thus, some implementations may make use of ultrasonic vibration.

One implementation of the PASS sampling system is less than one quarter of the size of the TSA's EDS specifications and has seven times the throughput. Based on TSA data, the expected false alarm rate of approved trace detectors should be less than one percent. Operationally, low false alarms will translate into a significantly higher effective throughput, especially when compared to CTX's reported thirty percent rate of false alarms under typical usage conditions. Unlike systems that rely on density, which is a surrogate property, trace detectors rely for detection on the precise chemical structure of the explosive. This is the key reason why they have such a low false alarm rate.

Because of its effectiveness at scavenging explosive residue, the PASS is also capable of detecting IEDs containing one tenth to one hundredth of the amount of explosive that can be detected by current systems. There is also no radiation hazard presented by the PASS machinery. At the same time, the PASS is an inherently simple system, and should cost less than one third of current systems to produce in 100 unit quantities. The basic components of PASS are industrial grade heavy equipment components, such as a compressor, simple pressure vessels, simple pressure seals, control valves, conventional gas plumbing fixtures and controls, conveyors, computers, and the like. These components are not only relative inexpensive, but they are also exceptionally reliable and readily available. The major components that need to be specially fabricated and tested are the pressure-vacuum chamber, the door mechanism, and the system operating software and controls. The mechanical simplicity translates into lower anticipated annual maintenance costs. Moreover, the PASS provides fully automatic data interpretation, which leads to shorter training and less room for human error.

The PASS can be deployed in different parts of the airport. It can be used as a stand-alone system or complementary to the CTX units currently used to make use of the strengths of both systems. Listed following are different possible deployment scenarios. The ideal scenario may be different for different airports, or even in different parts of the same airport.

The PASS may be deployed, for example, at a security check prior to baggage check-in. In this scenario, there is a large central security checkpoint, which may contain a multitude of stations, to check all carry on luggage. Passenger ID, and passenger profiling, if used, would occur at this stage. The use of the PASS could be integrated with a CTX device at the same location for improved security checks. After being clearing at the security checkpoint the passenger would then proceed to the baggage check-in counter. Since the average time for baggage check in is greater than the average time for the security check, fewer security check points may be required than the number of baggage check-in counters.

The PASS might alternatively be deployed at baggage check-in. In this scenario, the PASS would be integrated with the baggage check-in counter. If not fully automated, the baggage check in clerk would physically remove a small sample filter from the PASS and place it in the trace-level explosives detector 165.

The PASS could also be deployed at the carry-on security check. For additional security, a PASS device could be integrated along with the currently used X-ray equipment at the security check in gates of the airport, complementing the already installed equipment. It could be designed to make use of the currently existing trace explosives detection systems.

In another scenario, the PASS could be deployed at baggage handling and make up areas. One challenge at airports is the clearing of transfer luggage. The PASS would be ideal for this application, both as a stand alone, or complementary to the CTX units. It could be set up at any convenient area within the baggage make up area.

In one implementation, the PASS can be used in place of full-scale CTX systems. As an alternative, the PASS can also be designed to meet the target requirements of the TSA's ARGUS program. For example, the ARGUS specification lists both military and certain commercial explosives that are required to be detected. The three approved trace-level explosives detectors have all been shown to be capable of detecting plastic explosives, TNT, and NG. They have not been approved for detecting ammonium nitrate-based explosives and various black powders. Dynamite typically contains either NG and/or EGDN and is easily detected by the TSA-approved explosives detectors.

Additional windows need to be opened on the ion mobility detectors so that they can be tuned to detect certain constituents of ammonium nitrate, black powder, Pyrodex, single-based propellants, double-based propellants, and triple-based propellants. In addition, various stabilizers are added to ammonium nitrate-based explosives that can also be detected by ion mobility detectors.

Black powder always contains sulfur, which can be detected by means of its oxidation products, SO₂ or SO₃. In addition, these formulations generally contain trace residues of DNT and/or NG, which can be detected using standard ion mobility. A less flammable black powder substitute is Pyrodex. It is shipped as a flammable solid, instead of as a Class A explosive. In addition to sulfur, Pyrodex also contains sodium benzoate and sodium dicyanamide, which are amenable to detection by ion mobility.

Single-based propellants are typically made from nitrocellulose, with traces of 2,4,DNT. Common impurities include diphenylamine and ethylcentralite, both of which can be detected by ion mobility. Double-based propellants, by definition, contain either NG or EGDN, both of which are detected by standard ion mobility. Triple-based propellants typically contain nitroguanadine as well as NG.

The ARGUS specification also requires that the explosives detection system accept bag sizes up to 92 cm×75 cm×51 cm. In general, the system is designed to accept the largest possible bag. This target-sized bag is significantly larger than the typical bag. The target size would result in a volume that would accommodate three to six bags of a more conventional size, which would allow for the screening of a typical family unit's checked luggage in one large sample at the time of check in.

The ARGUS specification requires throughput of at least 50 bags per hour. As discussed above, the PASS should be able to accommodate a throughput of at least 180 bags per hour per chamber. Thus, a dual pressure chamber PASS would provide an expected throughput of about 360 bags per hour.

The ARGUS specification, because of its focus on smaller airports and small screening stations, requires the ability to provide single-sided access to the screening apparatus. The nature of the design of the PASS is such that it can be configured for single-sided or flow-through (i.e., two-sided) access, depending upon the desired configuration for a given installation. In a single-sided implementation, the luggage 112 could be ejected from the same side and through the same door 110 as used for loading the luggage 112 into the pressure chamber 105. A PASS that provides flow-through access, on the other hand, could include a conveyor system that loads the luggage 112 into the apparatus through a first door 110 on one side and ejects the luggage 112 through a second door 110 on another side (as depicted in FIG. 1). Unlike a CTX system, the PASS conveyor should be only a few inches off the floor. The only item that resides under the conveyor 115 will be the mechanical drives for the conveyor 115, and possibly the vibration machinery, if it is included. This low conveyor height will make it easier for passengers to load their own bags on the feed conveyor 115, which should be at floor level.

Another requirement of the ARGUS specification is that the system's footprint is not to exceed 210 cm×335 cm. The needed footprint for a CTX system is 7 square meters. By comparison, the PASS can be implemented in an apparatus that has a footprint of about 128 by 162 cm, or 2 square meters, which is roughly 30% of the space required for a CTX system. In addition, the PASS can be implemented with a height that is approximately half that needed for a CTX system. In one implementation, it is possible to take advantage of the allowable height to have the doors 110 of the pressure chamber 105 either move vertically up and down, or even possibly be inside the pressure chamber 105 and open in a similar manner to a garage door. In addition, much of the system utilities and pressure pumps can be located above the pressure chamber(s) 105.

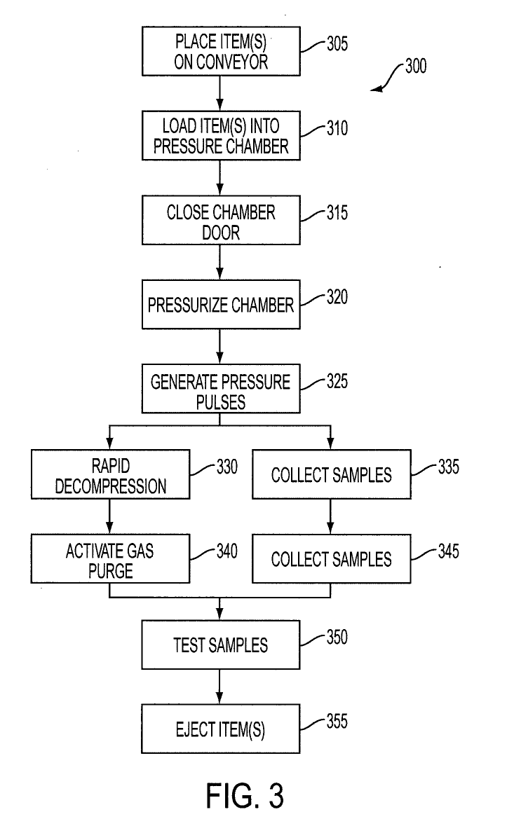

FIG. 3 illustrates a process 300 for screening a container, such as an item of luggage 112, for contaminants. First, a passenger or an operator of the screening apparatus places one or more items on a conveyor 115 (step 305). The operator presses a button that causes the conveyor to propel the items into a pressure chamber 105 (step 310). Automatic light beams determine whether there are any trailing straps that could interfere with the proper closing of the pressure chamber door 110, and the pressure chamber door 110 closes automatically (step 315).

Once the door 110 is closed and any integrated safety locks are engaged, the automated sampling process is initiated with a slow pressurization of the pressure chamber 105 (step 320). Once the pressure chamber 105 reaches a predetermined pressure level, the pressurization is maintained for a period of time sufficient to allow the pressure chamber to reach approximate pressure equilibrium. This period of time can be predetermined based, for example, on empirical data from experimental tests or simulations. Alternatively, a pressure gauge can provide, to a control system for the apparatus, control signals indicating the pressure level. By waiting for the control signals to indicate that the pressure level inside the pressure chamber 105 has somewhat stabilized (i.e., that the pressure has stopped dropping), it can be determined when the approximate pressure equilibrium is reached. In some implementations, after the pressure equilibrium is achieved, a series of pressure pulses are generated (step 325).

Next, rapid decompression is initiated by venting the pressure chamber 105 to the ambient atmosphere (step 330). Simultaneously with the decompression or a portion thereof, particle and/or vapor samples are collected (step 335). The samples may be collected by one or more different collection media (e.g., an impactor-style collector and/or a filter-type collector). In addition, the samples may be collected only during a stage or stages of the decompression in which vapors and particles from the exterior or interior of the items being tested are expected to be present. Once the pressure chamber 105 is at or near atmospheric pressure, a gas purge is initiated by rapidly opening a valve through which pressurized air or other gas is released into the pressure chamber 105, thereby clearing any remaining particle-enriched or vapor-enriched air from the pressure chamber (step 340). Samples are again collected simultaneously with the gas purge (step 345) using either the same collection medium or media used in step 335 or a different collection medium or media.

Once the pressure chamber 105 is fully decompressed and the gas purge is complete, the samples are then tested for contaminants that might evidence the presence of explosives, biological or chemical agents, and/or narcotics (step 350). In one implementation, the operator removes a small material sample filter from a sample holder and places the filter in an ion mobility detector or a gas chromatograph coupled with a chemiluminescence detector. The analyzer automatically carries out its analysis and displays the result as PASS or FAIL. A FAIL could also be accompanied by a description of the type of explosive or other contaminant that had been found. In an alternative implementation, the testing of the sample can be performed by automatically transferring the sample to the analysis device without human intervention. At the end of the sampling cycle, the pressure chamber door 110 opens, and the item or items are automatically ejected or the operator ejects the item or items by pressing a button (step 355). The system would then be ready for the next passenger.

Although illustrated and described in a particular order, the process steps need not be performed in the order specified. For example, testing of one or more samples may begin before the gas purge of step 340 is complete. Alternatively, sample testing might not occur until after the item is ejected at step 355.

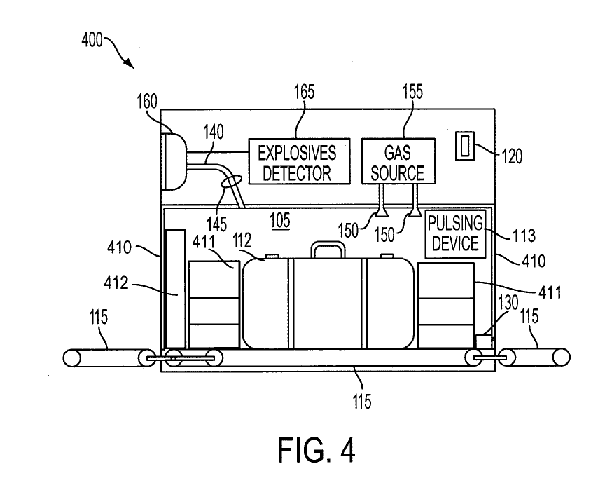

FIG. 4 shows a schematic cross-sectional side view diagram of a PASS 400. Like PASS 100 depicted in FIG. 1, the PASS 400 includes a pressure chamber 105 that includes doors 410 that are fitted with pressure seals to prevent air from leaking out of the pressure chamber 105 around the edges of the doors 410. The pressure chamber 105 also includes filler objects 411, such as an object that can be placed in the chamber before screening so that the object is present in the chamber during the screening of one or more items being screened. The filler object may be a substantially incompressible object, such as a substantially incompressible foam block fabricated from polyurethane foam or a metal form. In some implementations, the filler object may be compressible. For example, a compressible filler object may be a bag that is inflated with gas or an object made from a compressible foam material. A compressible filler object may be modifiable such that the object conforms to the shape of the item (or a portion of the item) being screened. In this example, one of the doors 410 includes (or is adjacent to) a filler object 412.

In the example of PASS 400, filler objects 411 are placed on the conveyer belt 115 such some of the filler objects 411 enter and exit the chamber before the item 112 to be screened and others of the filler objects 411 enter and exit the chamber after the item 112 to be screened. As illustrated, the filler objects are in the pressure chamber 115 while the item 112 is being screened.

In some implementations, the pressure chamber 105 may include filler objects in addition to or in lieu of filler objects 411 and 412. For example, a filler object or objects may be placed at least partially underneath and/or at least partially above the item to be screened (here, luggage 112). The insertion or inclusion in the pressure chamber of fillers decreases the internal volume of the pressure chamber, which reduces the volume to be sampled, which, in turn, helps to more easily achieve a specified depressurization rate. For example, in a system that uses multiple valves to depressurize the pressure chamber, fewer valves may be needed to achieve a specified depressurization rate.

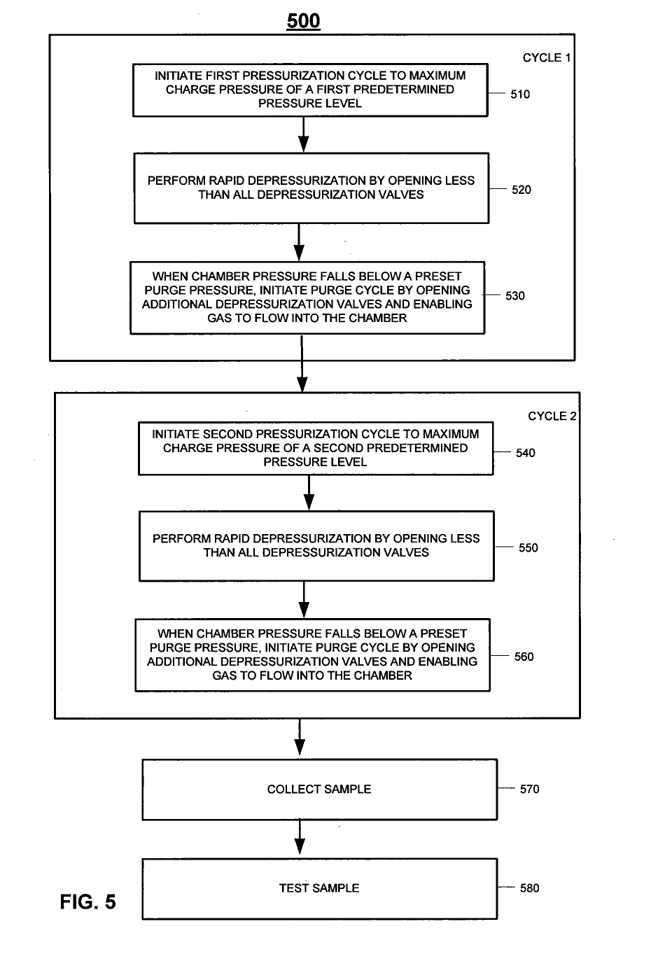

A filler object or objects may be added to the pressure chamber based on the size or volume of the item to be screened. For example, more filler objects may be added to the pressure chamber for a smaller item to be screened, as compared with the number and volume of filler objects added to the pressure chamber for a larger item to be screened. FIG. 5 illustrates a process 500 for screening a container, such as an item of luggage 112 or a cargo container, for prohibited material or contaminants. The process 500 can be generally implemented using a PASS, such as PASS 100 shown in FIG. 1 or PASS 400 shown in FIG. 4. A PASS performing process 500 includes multiple depressurization valves and multiple gas nozzles. In the implementation of process 500, the PASS includes multiple depressurization valves, each valve connected to a vent. In one example, a pressure chamber may have nine depressurization valves, each connected to a vent. The opening of multiple valves enables the chamber pressure to fall rapidly below a preset purge pressure.

In general, to perform the process 500, the PASS completes multiple cycles where each cycle includes a pressurization cycle, a rapid depressurization operation, and a purge operation. Once the multiple cycles have been completed, the sample is collected and tested.

More particularly, in the example of process 500, a first cycle includes a first pressurization cycle 510 to a maximum charge pressure of a first predetermined pressure level, a rapid depressurization 520, and a purge operation 530. In the example of process 500, rapid depressurization is accomplished by opening less than all depressurization valves of the pressurization chamber and the purge operation is performed by opening additional depressurization valves once the chamber pressure falls below a predetermined purge pressure and enabling a gas flow into the pressure chamber. In some implementations, all depressurization values may be opened to rapidly depressurize the pressure chamber. The gas flowing into the chamber creates a purge flow. Because the velocity of the exhausting gas is high, the momentum of the gas flow continues to force additional gas out of the chamber after the chamber has reached ambient atmospheric pressure. The purge flow prevents a vacuum from forming in the chamber, thus preventing the exhausted material from being sucked back into the chamber. The gas used during the purging process can be, for example, ambient or purified air or some type of inert gas, such as argon or nitrogen.

The process 500 also includes a second cycle of pressurization 540, rapid decompressing 550, and purging 560. After the completion of multiple cycles (in the example process here, two cycles), sample material is collected 570 and tested 580. Collecting sample 570 may be an implementation of step 345 described previously with respect to FIG. 3, and sample testing 580 may be an implementation of step 350 described previously with respect to FIG. 3.

In some implementations, a pressurization cycle or cycles may be followed by a rapid depressurization without necessarily including a separate purge cycle. Also, a process that has more than two pressurization/rapid depressurization operations (with or without purge operations) is contemplated. One example implementation may include three cycles of pressurization/rapid depressurization where the first two cycles of pressurization/rapid depressurization pressurize the chamber to a lower maximum pressure than the last cycle of pressurization/rapid depressurization. For example, a process may include a first pressurization cycle that pressurizes the chamber to around 20 pounds per square inch gauge (psig) before rapidly depressurizing the pressure chamber a first time; a second pressurization cycle that also pressurizes the chamber to around 20 psig before rapidly depressurizing the pressure chamber a second time; and a third pressurization cycle that pressurizes the chamber to around 40 psig before rapidly depressurizing the pressure chamber a third time before collecting and testing the sample. In another example, the pressure chamber may be pressurized to the substantially the same pressurization level in all pressurization/rapid depressurization cycles. In yet another example, implementations may include five pressurization cycles of around 20 psig, 25 psig, 20 psig, 35 psig and 40 psig, respectively, with each pressurization cycle followed by rapid depressurization (with or without purge operations).

In some implementations, a PASS may include various numbers of depressurization valves and multiple gas nozzles. In a more particular example, a PASS may include nine depressurization valves and multiple gas nozzles, each nozzle having a diameter of around four inches. A depressurization operation is initiated by opening some but not all of the valves. For example, six of the nine valves may be opened during a depressurization operation. A purge operation is performed by opening more valves, such as the remaining valves and opening the nozzles allowing the purge flow to enter the chamber.

A number of implementations have been described. Nevertheless, it will be understood that various modifications may be made. For example, the techniques may be applied in the context of testing large cargo containers or other items for contaminants of any kind. In addition, the techniques may be used in connection with heat, vibration, CAT scans, or X-rays, which may, in some implementations, provide some assistance in detecting contaminants. Furthermore, instead of using atmospheric air to pressurize the pressure chamber, some other type of gas, such as an inert gas or purified air, can be used. Accordingly, other implementations are within the scope of the following claims.

What is claimed is:

1. A system for screening an item for prohibited material, the system comprising:
a pressure chamber adapted to contain at least one item to be screened for prohibited material and being adapted to contain at least one filler object;
a pressurized gas source connected to provide pressurized gas to the pressure chamber;
a valve for venting the pressure chamber to an ambient atmosphere;
a controller operable to control a pressurization of the pressure chamber by the pressurized gas source and to control the valve to initiate a rapid decompression of the pressure chamber; and
a sample collector positioned to collect samples of substances removed from the at least one item by the rapid decompression.

2. The system of claim 1 wherein the at least one filler object comprises at least one substantially incompressible filler object.

3. The system of claim 1 wherein the at least one filler object comprises at least one polyurethane foam object.

4. The system of claim 1 wherein the at least one filler object comprises at least one formed metal object.

5. The system of claim 1 wherein the pressure chamber includes at least one door for loading the at least one item into and out of the pressure chamber, at least one of the at least one filler object is connected to the at least one door.

6. The system of claim 1 wherein the pressure chamber is adapted to contain at least one of the at least one filler object located at least partially beneath the at least one item to be screened for prohibited material.

7. The system of claim 1 wherein the pressure chamber is adapted to contain at least one of the at least one filler object located at least partially above the at least one item to be screened for prohibited material.

8. The system of claim 1 wherein the pressure chamber is adapted to contain at least one of the at least one filler object located at least partially adjacent to the at least one item to be screened for prohibited material.

9. A method for screening an item for prohibited materials, the method comprising:
placing an item in a pressure chamber, the pressure chamber including at least one filler object;
pressurizing the pressure chamber up to a predetermined pressure level;
decompressing the pressure chamber at a rapid rate relative to a rate of pressurization; and
collecting samples of substances removed from the item by the rapid decompression.

10. The method of claim 9 wherein the at least one filler object comprises at least one substantially incompressible filler object.

11. The method of claim 9 wherein the at least one filler object comprises at least one polyurethane foam object.

12. The method of claim 9 wherein the at least one filler object comprises at least one formed metal object.

13. The method of claim 9 wherein the pressure chamber includes at least one door for loading the at least one item into and out of the pressure chamber, at least one of the at least one filler object is connected to the at least one door.

14. The method of claim 9 wherein the pressure chamber is adapted to contain at least one of the at least one filler object located at least partially beneath the at least one item to be screened for prohibited material.

15. The method of claim 9 wherein the pressure chamber is adapted to contain at least one of the at least one filler object located at least partially above the at least one item to be screened for prohibited material.

16. The method of claim 9 wherein the pressure chamber is adapted to contain at least one of the at least one filler object located at least partially adjacent to the at least one item to be screened for prohibited material.

17. The method of claim 9 wherein the rapid rate is at least about ten times the rate of compression.

18. The method of claim 9 further comprising generating pressure pulses after the pressure chamber reaches the predetermined pressure level and before the rapid decompression of the pressure chamber.

19. The method of claim 9 wherein venting the pressure chamber to the ambient atmosphere allows air to escape the pressure chamber at a high velocity.

20. The method of claim 9 wherein the high velocity comprises a velocity sufficient to effectively strip particles adhering to a surface of the item.

21. A system for screening an item for prohibited material, the system comprising:
a pressure chamber adapted to contain at least one item to be screened for prohibited material;
a pressurized gas source connected to provide pressurized gas through multiple nozzles to the pressure chamber;
multiple valves for venting the pressure chamber to an ambient atmosphere;
a controller operable to control multiple pressurization of the pressure chamber by the pressurized gas source and to control the valves to initiate rapid decompressions of the pressure chamber opening some but not all valves to vent the pressure chamber and initiate a purge of the pressure chamber after the rapid decompression by opening additional valves to vent the pressure chamber than used in the rapid decompression of the pressure chamber and using the multiple nozzles to provide gas to the pressure chamber; and
a sample collector positioned to collect samples of substances removed from the at least one item by the rapid decompression.

22. The system of claim 21 wherein the purge is initiated once the pressure in the pressure chamber falls to a preset pressure level.

23. A method for screening an item for prohibited materials, the method comprising:
placing an item in a pressure chamber;
pressurizing the pressure chamber a first time up to a first predetermined pressure level;
after pressurizing the pressure chamber the first time, decompressing the pressure chamber a first time at a first predetermined rapid depressurization rate;
after decompressing the pressure chamber the first time, pressurizing the pressure chamber a second time up to a second predetermined pressure level;
after pressurizing the pressure chamber the second time, decompressing the pressure chamber a second time at a second predetermined rapid depressurization rate; and
collecting, from the sample collector, samples of substances removed from the item by the rapid decompressions.

24. The method of claim 23 wherein the first predetermined pressure level is substantially the same as the second predetermined pressure level.

25. The method of claim 23 wherein the second predetermined pressure level is higher than the second predetermined pressure level.

26. The method of claim 23 wherein:
decompressing the pressure chamber a second time comprises decompressing the pressure chamber a second time at a predetermined rapid depressurization rate by opening some but not all pressure valves to vent the pressure chamber; and
when the pressure in the pressure chamber has reached a predetermined purge pressure level that is less than the second predetermined pressure level, purging the pressure chamber by opening additional pressure valves to vent the pressure chamber and opening nozzles to provide a gas flow in the pressure chamber from the nozzles toward a sample collector.

27. The method of claim 26 wherein:
the pressure chamber includes at least eight valves,
depressurizing the pressure chamber includes opening at least five valves; and
purging the pressure chamber includes opening at least three valves.

28. A method for screening an item for prohibited materials, the method comprising:
placing an item in a pressure chamber;
pressurizing the pressure chamber a first time up to a first predetermined pressure level;
after pressurizing the pressure chamber the first time, decompressing the pressure chamber a first time at a predetermined rapid depressurization rate;
after decompressing the pressure chamber the first time, pressurizing the pressure chamber a second time substantially up to the predetermined pressure level;
after pressurizing the pressure chamber the second time, decompressing the pressure chamber a second time at a second predetermined rapid depressurization rate;
after decompressing the pressure chamber the second time, pressurizing the pressure chamber a third time up to a second predetermined pressure level, the second predetermined pressure level being a higher pressure level than the first predetermined pressure level;
after depressurizing the pressure chamber the third time, decompressing the pressure chamber a third time at a third predetermined rapid depressurization rate by opening some but not all pressure valves to vent the pressure chamber;
when the pressure in the pressure chamber has reached a predetermined purge pressure level that is less than the second predetermined pressure level and greater than the first predetermined pressure level, purging the pressure chamber by opening additional pressure valves to vent the pressure chamber and opening nozzles to provide a gas flow in the pressure chamber from the nozzles toward a sample collector;
collecting, from the sample collector, samples of substances removed from the item by the rapid decompressions and purge.
